(19) United States
(12) Patent Application Publication
(10) Pub. No.: US 2007/0262288 A1
(43) Pub. Date: Nov. 15, 2007

(54) Inorganic fluorescent powder as a solid light source

(76) Inventor: Soshchin Naum, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/429,991

(22) Filed: May 9, 2006

(51) Int. Cl. C09K 11/66

(52) U.S. Cl. 252/301.4 F

(57) ABSTRACT

This is one type of inorganic fluorescent powder that can be used as a solid light source for a UV light. The inorganic fluorescent powder is produced based on garnet silicates and can be activated by rare earth ions. The main composition of this inorganic fluorescent powder is Me⁺²_{2.5-x-y}Ln⁺³_{3-q-z-p}Si_{2.5}O₁₂:Lm₁⁺²_{X}:Lm₂⁺²_{Y}:Lm₃⁺³_{Z}:Lm₄⁺³_{P}. The inorganic fluorescent powder utilizes the excited conditions of short wave light emitted during the combination of different semi-conductors to establish white light radiation with multiple bands. Color temperatures range from 2500° K to 12000° K.

### BACKGROUND OF THE INVENTION

1. Field of the Invention

An inorganic fluorescent powder for UV light is used in this invention as the re-radiation surface coating of solid light source. It converts short wave radiation from light emitting materials into white light.

2. Description of Related Art

White light (especially white light from a solid light source) is a mixture of multiple colors of light. What the human eye perceives as white light is actually a combination of light of two or more wavelengths. When simultaneously stimulated by red, blue and green light, or, simultaneously stimulated by supplementary blue and yellow lights, the human eye perceives the light as white light. Solid light sources providing white light can be produced based on this principle.

Four methods are commonly used in producing solid light sources for white light:

The first method uses three solid light sources utilizing InGaAlP, GaN and GaN/GaP as materials, which control the electric currents (and when passed through) passing through and emit red, green and blue light, respectively. The three lights are then mixed via lens to generate white light.

The second method uses two solid light sources utilizing GaN and GaP as materials, which control the currents passing through and emit blue and yellow-green light to generate white light.

Although the efficiency of illumination of the above mentioned two methods reaches 201 m/W, should any individual solid light source fail, normal white light cannot be obtained. Moreover, since a forward bias varies from light source to (light) source, several sets of control circuits are required, thereby increasing costs. All these methods therefore have their own disadvantages.

The third method was developed in 1996 by Nichia Chemical of Japan. This method uses a blue light solid light/solid blue light source of indium nitride gallium and a yellow-light-emitting yttrium aluminum garnet fluorescent material to form a white light source. At present, although the efficiency of illumination (a maximum of 151 m/W) is lower than that of the previous two methods, this method requires only one solid light source control chip, thereby significantly reducing production costs. Furthermore, the formulation and production technology of the fluorescent material has matured and commercial products are already available.

However, since complementary color principles are used in the last two methods to generate white light, the continuity of wavelength distribution in the spectrum is not as good as that of natural sun light. Colors in the spectrum of the visible light range (400 nm˜700 nm) are not even, after the mixing of color light, and the color saturation is low. Although such phenomena will be unnoticeable to the human eye (only white light is seen), color rendering is in reality low under the sensing of high precision photo detectors, such as video cameras or cameras. That is, color loss may occur during color restoration. Thus, white light source generated by these methods can only be used for simple lighting applications.

The fourth white light generating method was developed by Sumitomo Electric Industries, Ltd. of Japan, which uses ZnSe material as the solid light source of white light. This technology was the first to form a film of CdZnSe on a ZnSe single-crystal substrate. After being electrified, the thin film emits blue light, and part of the blue light strikes the substrate and emits yellow light. Finally, the blue and yellow light complement each other and generate white light. This method utilizes only a single crystal as a solid light source and the operation voltage is only 2.7V, which is lower then the 3.5V required for a GaN solid light source. Furthermore, no fluorescent material is required for the generation of white light. However, the illumination efficiency is only 81 m/W, and the service life is just 8000 hours. Both these problems are disadvantages that prohibit practical application of this technology and further breakthroughs will be required before this method can have real-world applications.

In addition to the above-mentioned methods of white light generating with solid light sources, another widely known method is the use of the UV in a solid light source chip as described in U.S. Pat. No. 6,765,237 “White light emitting device based on UV solid light source and phosphor blend”, in which the composition of two chemicals forms a solid fluorescent emitting white light while activated by UV. Furthermore, U.S. Pat. Nos. 6,853,131 and 6,522,065, present a white light generating fluorescent body activated by UV, the main composition of which is the A₂₋₂ₓNa₁₊ₓEₓD₂V₃O₁₂. Elements A, E, and D and value x. are further defined.

The above-mentioned Nichia Company U.S. Pat. No. 6,614,179 suggests the use of the originally known cathode fluorescent body as the coating material for the heterostructure of In—GaN indium gallium nitrides. The composition of the cathode fluorescent body is Y₃Al₅O₁₂:Ce (yttrium aluminum garnet: cerium). The maximum wavelength in the spectrum of the heterostructured radiation is λ=465 nm. The heterostructured radiation activates the fluorescent body of yttrium aluminum garnet and emits a strong fluorescent light. The strongest radiation is between 540-580 nm, which is in the range of yellow color/light of the visible electronic spectrum. When such secondary yellow light is mixed with part of the initial blue radiation (λ=465 nm), white radiation is generated and the specific color temperature ranges from T=12000° K to T=8000° K. The composition ratios of yttrium aluminum garnet: cerium in similar patents with in-depth studies have been modified many times. Despite all the efforts to perfect it, some fundamental drawbacks still remain:

1. The fluorescent body presents a very low absorption of the initial radiation emitted by the solid light source for blue light

2. The material costs of the fluorescent body are high.

3. A high temperature of 1600° C. is required to synthesize the fluorescent body.

However, in the patent of a prototype owned by Japan's Mitsubishi Company (US patent US2004/0251809), attempts have been made to eliminate such fundamental drawbacks of the fluorescent body. They suggest that the composition of the fluorescent body be Me⁺²₃Me⁺³₂Si⁺⁴₃O_{δ}:Ce. Here, Me⁺² is a double valence metal; Me⁺³ is a rare earth metal Y, Sc or Gd; δ is a chemical formula coefficient, from 11 to 13. Even if that is the case, it suggests the possibility of using other ions (such as Eu, Pr, and Dy etc.) to activate the fluorescent body. However, in the application case, when applied to a light source/fluorescent light body, the suggested fluorescent body is activated mainly by a Ce⁺³ ion. But it does not release the detailed properties and compound characteristics of the fluorescent body. Compared to the defects and limits of known technologies, this/the present invention suggests a completely new fluorescent inorganic powder. Within it, the solid light source possesses a higher Rendering index. This light emitting material is used as the re-radiation surface coating for the solid light source. The short wave radiation of this light emitting material can then be converted into visible light, especially white light.

### SUMMARY OF THE INVENTION

The object of this invention is to produce a fluorescent inorganic powder capable of emitting a strong light so that the powder may be used as a short wave solid light source. Another object is to produce a fluorescent inorganic powder that emits light that can completely cover a half wave segment of a blue-green-yellow-orange-yellow visible light. A further object is to develop a fluorescent inorganic powder's actual formulation that is based on the synthesis of regeneration technology. And, this invention is based on that, when actually synthesizes the fluorescent inorganic powder, the formulation does not require expensive reagents to reduce costs.

The composition of the fluorescent inorganic powder described in this invention is based on a garnet silicate fluorescent inorganic powder composition. It can be activated by rare earth ions. This is different from other fluorescent body with chemical formula. The composition of this fluorescent inorganic powder is Me⁺²_{2.5-x-y}Ln⁺³_{3-q-z-p}Si_{2.5}O₁₂:Lm₁⁺²_{X}:Lm₂⁺²_{Y}:Lm₃⁺³_{Z}:Lm₄⁺³_{P}.

Where, Ln is Y, Gd, Sc and are Lu series rare earth elements; Lm₁⁺² are Eu⁺², and Sm⁺² are series double valence rare earth ion activation agents; Lm₃⁺³ are Ce⁺³, Eu⁺³, Tb⁺³, and Pr⁺³ are series tri-valence rare earth ion activation agents; Lm₂⁺² are Sn⁺² and Mn⁺² series d-element double valence rare earth ion activation agents; Lm₄⁺³ are Bi⁺³ and Cr are series tri-valence rare earth ion activation agents, TR⁺², TR⁺³, and Me⁺², one or more of them form activation center for emitting light and priority arranged in the double valence center of the cation of the Mg octahedron shape. Then, it forms a light emitting tri-valence center, priority arranged on the nodes of the Lauryl shape rare earth elements. They can then be used under the semi-conductor's different material combination to emit short wave light exciting conditions to establish multiple band radiation. This radiation is white light. The color temperature is from between 2500K to 12000K.

### BRIEF DESCRIPTION OF THE DRAWINGS

No drawings are included with the description of the preferred embodiments.

### DETAILED DESCRIPTION OF PREFERRED EMBODIMENTS

In this invention, the fluorescent inorganic powder for UV light solid light source includes three or four types of activation mixtures. Their main radiation items are the conversion of electronic states participated by d and f. That is, the f-d and d-d-conversion. The precision limitation of activation ions may establish multiple band radiation. This type of radiation may be separated into individual single bands. The half width of each band is λ_{0.5}=30-50 nm (nano meter). The radiation band of Ce⁺³ ion is the largest. It is λ_{0.5}=90-110 nm. But, when using specially selected Ln series components, the bandwidth may be reduced.

The important properties of the fluorescent inorganic powder implementation method presented in this invention have two types of residue light:

(1) Short attenuation type, that is, d-f-conversion of ion Eu⁺² and Ce⁺³ set; and

(2) Medium attenuation type, that is d-d conversion of ion Mn⁺², Sn⁺² and Bi⁺³ set.

An important property of another fluorescent inorganic powder implementation method presented in this invention is that it can effectively absorb short wave light coming from dissimilar material semi-conductor. Among them, the standard fluorescent inorganic powder with only one type of activation agent Ce⁺³, light energy absorption is related to the d-f conversion of Ce⁺³ ion. Thus, at the beginning, the absorption of external light is in proportion to the Ce⁺³ ion concentration added to the formulation of the fluorescent inorganic powder. When the wavelength is λ=450 nm, the reflective coefficient of the fluorescent inorganic powder activated by Ce⁺, is normally R₄₅₀=20-25%. Under a wavelength λ=510 nm, the reflective coefficient is within the green color light spectrum, R₅₁₀75-90%.

In another example, the absorption of fluorescent inorganic powder is initially related to an electric charge movement band. TR⁺² ion and O⁻² oxygen ion form this type of band. That is, TR⁺²←O⁻². Thus, compared to a single Ce⁺³ ion, an electric charge-moving band can absorb much stronger light. Even when the added Eu⁺² activation ion concentration is not high, the absorption strength to the initial radiation of the different material combination increases in real terms. Between the range of λ=430 nm to 490 nm, the Eu⁺² ion has a strong absorption ability. At the same time, it activates the base of the chemical compound in this example. It can also be added and mixed with activation agents that carry moving band electric charges (such as Eu→O and Ce⁺³ activation ions). This increases the absorption of activated initialization energy.

Table 1 lists a comparison of the silicic acid composition suggested in this invention and the chemical formula of the Mitsubishi Company's prototype patent

TABLE 1

| Parameter | Mitsubishi common patent | This invention |
|---|---|---|
| Common chermical | M¹ₐM²_{b}M³_{c}O_{d} | Me⁺²_{2.5}Ln₃Si_{2.5}O₁₂ |
| formula | | |
| Value in the | M¹- double valence metal | Ln = Y, Gd, Sc, La |
| chemical formula | M²- tri-valence metal | Me⁺² = Mg and/or |
| | | Ca + Mg |
| | M³- four valence metal | |
| | a = 2.7-3.3 | a = 2.5 |
| | b = 1.8-2.2 | b = 3 |
| | c = 2.7-3.3 | c = 2.5 |
| | d = 11-13 | d = 12 |
| Crystal structure | Cubic structure | Cubic structure |
| Crystaline series | O¹⁰ₙ-Ja3d | O¹⁰ₙ-Ja3d |
| Crystal lattice | 12.4 A | 11.2-11.4 A |
| parameter | | |
| Quiantity of cation | | |
| laurylhedron | 16 units | 24 |
| octahedron | 30 | 20 |
| tetrahedron | 24 | 16 |
| Volume of A³ | >1700 A | ˜1400 A |
| crystal cell | | |
| Quantity of | 8 | 8 |
| component units in | | |
| the unit crystal | | |
| lattice | | |
| Density gm/cubic | 4.4-4.8 | 3.6-3.8 |
| mm | | |

In the listed detailed comparison description, the base materials for the fluorescent inorganic powder of this invention are different from Mitsubishi Company's in chemical formula (the suggested fluorescent body chemical formula is Me⁺²_{2.5}Ln₃Si_{2.5}O₁₂. and the chemical formula for Mitsubishi Company's is Me⁺²_{2.7-3-3.3}Me³_{1.8-2-3.3}Me³_{2.7-3-3.3}O₁₁₋₁₃. the crystal lattice is small, the volume is small and the gravity density is smaller). Based on measured results, this parameter is 3.6-3.8 g/cubic mm. The same as the known natural manganese aluminum type natural garnet, the densities of the similar compounds developed from the prototype patent are from p=4.4 g/cubic mm to p=4.8 g/cubic mm. Since the gravity density is lower, the garnet silicate of this invention is called a “light garnet”. From the results of comparison listed in Table 1, for the known materials and the suggested materials, the quantities of high positioning locations within the crystal lattice are the same. These are the same 24 cation nodes. However, within the low positioning nodes, Si⁺4 ion occupies 18 positions. Mg⁺² ion also occupies 6 positions. Starting from K=6, the medium positioning nodes are occupied by Mg⁺ ion. In a unit crystal lattice, there are 20 positions like these.

Comparing against known patents, the crystal lattice layout units of this invention have different quantities. This difference determines the pre-request conditions of all the layout units based on activation elements and determines the final defintive conditions to add activation elements into the compositions. For example, when adding 12 types of Ce⁺³, Eu⁺³, Tb⁺³, and Dy⁺³ ion layout conditions to the Ln nodes, the high radiation strength activation nodes can be established, that is, they are the activation agent.

Normally, the above-mentioned Lm⁺³ activation agent can acquire the narrow band radiation resulting from the f-f movement within the ion. For Ce⁺³ activation agent ions, the internal movement is restricted by broad band radiation energy conditions (which may cover visible light green, organe, and red segments). For crystal lattice K=4 and/or 6 low positioning nodes and medium positioning nodes, the distribution of Mn⁺², Sn⁺², and Eu⁺² ions are very good. They reqire that the nodes have a large linear range. For example, the ion dimension at K=4 is τ_{Mn}=0.6A. This is close to the value of an Mg⁺² tetrahedron, which has a positioning value of (τ_{Mg}=0.5 A).

Thus, in order for the crystal lattice to accept a larger Eu⁺² activation agent ion, value as τ_{Eu}=1.10 A, ion exchange must be carried out. The location of Mg⁺² ion shall be replaced with larger dimension Ca⁺² ion (τ_{Ca}=1 A). Under these conditions, part of the Mg⁺² 4 times positioning ion position appears to move to the geometry position of a larger dimension Ca ion (K=6). These larger geometry dimensions are suitable for the movement of Eu⁺² ion. Thus, although the structure volume of the “light garnet” is smaller, (V=23%), a larger dimension cation can be located to form an effective activation center.

From the above, we know that close contact between the large shape cation and an oxygen ion results in an increase of the crystal internal magnetic field. This is similar to known crystal magnetic field theory. The stringer magnetic field inside the crystal increases with the catalyst ion emitting position shifting probabilities. The latter reduces the residue light length of each ion. Under conditions in which the outer part of the semi-conductor's different material combination excites high strength light, the use of similar fluorescent materials is very important.

Another important property of the components Me⁺²_{2.2}Ln⁺³₃Si⁺⁴_{2.5}O₁₂Lm⁺³,Lm⁺² of this invention is that the implementation example material of this invention's chemical equivalent weight index is completely different from that of the prototype. The reason is that, in the prototype, the double valence metal chemicals are limited at an index of a=2.5. However, a normal composition's double valence elements' index is a=2.7-3.3. Among them, there are many tri-valence cation Me⁺³, that is, b=3 replaces the known compositions' b=1.8-2.2 atoms. Without doubt, this is similar to increase the strengthened magnetic field to the reaction of catalysts Lm⁺³ and/or Lm⁺². A large quantity of rare earth cation Ln⁺³ field will lead to that, within the recommended garnet, based on corresponding ratio of large catalysts Lm⁺³ and/or Tb⁺³ ion, the forming of large volume crystal lattice of the same crystals.

Simultaneously adding two light emitting cations will lead to the initial direct activation to form additional activation energy conversion sensitive mechanisms. For example, these are from Ce⁺³ to Tb⁺³ ion, from Tb⁺³ ion to Eu⁺³ ion, or from Bi⁺³ to Eu⁺³. The addition of sensitive mechanisms cannot change the light emitting strength of the main catalyst Lm⁺³. At the same time, it strengthens the of absorption ability of the initial activation energy. Thus, this implementation's example materials, catalyzed by Ce⁺³ and Tb⁺³, may strengthen the energy absorption of blue light diodes with wavelengths of λ=450 nm. So it would be expected that shorter wavelengths would be lower than λ<450 nm. In reality, they are λ=450 nm (UV light spectrum) and λ=375-385 nm (close to UV light spectrum area).

For the recommended materials, there is an ion exchange mechanism within the crystal lattices: the large dimension light emission ions, such as Sn⁺², Mn⁺², and Eu⁺² may enter Ln⁺³ positions and the different compounding valence exchange center. For example, for those (Sn⁺² Ln) carries deficient positive charges, that is, the center with similar negative charge−1. Even if they have good geometry compatibility, τ_{Sn+2}=1.22 A°, τ_{Ce}=1.09 A, they need electric charges for compensation. The similar compensation may be implemented through adding to the Ln⁺³ ion sub lattices, such as four valence elements. Sn⁺⁴ ion with ion radius τ_{Sn+4}=0.69 A, or Hf⁺⁴ ion with ion radius τ_{Hf}=0.91 A°, or Tb⁺⁴ with ion radius τ_{Tb+4}=1.08 A. Under these conditions, the number 1 and number 3 compensations ions' internal oxidation degree +4 should be considered stable in a neutral or an acidic environment. Furthermore, the number 2-Hf ion will not change oxidation degree under atmospheric conditions.

The valence combination center of the fluorescent dissimilation valence presents the main differences between the existence of the fluorescent inorganic powder of this invention and the known prototypes. The quantity of replacement dissimilation valence combination centers are few, close to a concentration [Sn⁺²_{Y}]≦1.0% atomic weight. However, these centers have obvious meaning to the fluorescent inorganic powder light emitting spectrum groups. For centers related to Sn⁺², they can emit the red light area at spectrum with wavelengths of λ=650 nm. At the same time, if the base center for fluorescent inorganic powder Eu⁺²_{Y}, light-emitting center is at the blue-green area it will absorb the UV light strongly.

One of the important properties of this example's fluorescent inorganic powder is that even if the production temperature of the fluorescent inorganic powder is T>1300° C. , the fluorescent inorganic powder does not contain large dimension particles. Among them, the fluorescent inorganic powder materials' median average diameter is 1.0<d₅₀<3.0 mm. The median average diameter of standard fluorescent body is d₅₀<2.5 mm. The average median diameter of high temperature synthesized standard yttrium aluminum garnet is d₅₀>6 mm. It can be assumed that it is affected by the close encapsulation of large particle ions. When the large catalyst ion particle under small dimension structure ion positions, the high temperature may lead to the crush of the fluorescent inorganic powder particles (that is the structure composition-crystal lattice's main structure). The non-valence equivalent exchange of the ions under geometry dimensions leads to the formation of significant mechanical stress within the fluorescent inorganic powder particles. This stress results in the crush of a whole block of particle structure being crushed into small particle components. This crushing action brings positive impacts and negative effects. The small particle fluorescent inorganic powder strengthens light scattering. The fragments of fluorescent inorganic powder particles do not have a neat prism structure of natural garnets. That is, a particle has 12 lines of angles or a corresponding 24 lines of angles. The difference in the fluorescent inorganic powder's particle prism shape is it has lower light scattering. The fragment shape particles scatter light and, at the same time, increase the surface area ratio. The surface area reflection of light meets emitting principle. That is, defined by the reflective coefficients of the material.

For example, when the ratios between the reflective coefficients of the fluorescent inorganic powder in this invention and the combined connection coefficients are from 1.65:1.45 to 1.8:1.55, it will form a stable suspension. Among them, the mass contents of the fluorescent inorganic powder particles are 10-75%. This will form a uniform layer with a thickness of between 20 mm to 200 mm.

Another important characteristic of the garnet structure of this silicate fluorescent inorganic powder is that it has a lower reflection coefficient, nᵣₚ≦1.75, than the traditional yttrium aluminum garnet Y₃Al₅O₁₂, n≧1.85-1.92. The low reflective coefficient of the magnesium silicate garnet not only lowers light scattering but also increases the effective area of the fluorescent inorganic powder transfer light flow. Thus, the semi-conductor's different material combination surfaces are coated with silicone compounds polymer or epoxy, special solidification compounds and optical activation additives, etc., and special components. Under these conditions, the smaller the phase differences of the reflective coefficients between the natural compounds and the fluorescent inorganic powder, the larger the output angle from the fluorescent inorganic powder particles. The standard yttrium aluminum fluorescent body reflective coefficient is n=1.85. While the magnesium garnet coefficient is n=1.72. The difference is close to 7%. This increases the light output angle by 20-25%. At this time, the important properties of the fluorescent inorganic powder components not only increase a light emitting strength J (Joule) of the semi-conductor's solid light source, but it also simultaneously increases the light flow Φ (lumen) and light output performance of the equipment η (watt/watt). Furthermore, within the fluorescent inorganic powder sub crystal lattice, the magnesium ion Mg⁺² replaces the calcium ion Ca⁺² by 1.5-3%. The reflective coefficient of the fluorescent inorganic powder material is lowered to n=1.68. This reduction lowers the difference in the reflective coefficients between the fluorescent materials and the surrounding compounds. Thus, the suggestion is that a small amount of the magnesium ion Mg⁺² in the fluorescent inorganic powder is replaced by the calcium ion Ca⁺². The results are also beneficial.

This invention has a fluorescent inorganic powder material energy conversion mechanism and it is compared to the Y₃₋ₓCeₓAl₅O₁₂ fluorescent body activation mechanism. Normally, the latter is a yellow powder, or flesh colored materials. This is based on the contents of the Ce⁺³ in the material (four valence Ce⁺⁴ will affect the color of the fluorescent body; Ce⁺⁴ may be preserved in the material during the Ce⁺⁴O₂ oxidation environment synthesis process). In one of the examples, no yellow Ce⁺³ ion exists in the o-silicate rare earth elements, for example Y₂₋ₓCeₓSiO₅. However, the yellow color on the normal cerium ion catalyzed garnet fluorescent body is caused by 4f-5d condition Ce⁺³ activation. Under these conditions, Ce⁺³ ion is absorbed completely and meets ion capability separation hv=2.45 eV to hv=2.50 eV or based on a wavelength from λ=470 nm to λ=450 nm.

A cerium catalyzed fluorescent body activation process is carried out through each individual ion. Similar atomic activation attenuates vary rapidly. The time is less than 1·10⁻⁷ seconds. Under these conditions, each cubic mm of fluorescent body material emits quanta as high as 1026 per second. This high radiation strength states that, in practice, the initial activation condition of fluorescent body, in the range between 1·10⁻⁶ volts/cm³ to 1·10³ volts/cm³, lacks non-linear conditions. The activation energy conversion to a catalysis mechanism is as described above. It is only effective to actual short damping catalytic ions, such as Ce⁺³. For ions with long residual light, for example τₑ=2 ms for the Eu⁺³ ion, the activation energy attenuation is very slow, approximately ˜1·1020 quanta/second. Thus, for this type of catalytic center, there may be saturation phenomena.

There is a delay during the initial activation period. Thus, not all activated energy quanta will react with the catalytic atoms. With the increase in activation energy, the quantity of non-transparent atoms reduces rapidly. Thus, at the activation energy level of W=0.1 volts/cm³, it reaches energy transmission saturation. Similar transmission sub-linear mechanism is not limited to Eu⁺³. Tb⁺³ ion also possesses this property. The attenuation period is τ≦1 ms. To eliminate the slow activation speed of the Tb⁺³ catalyzed fluorescent body, in the invention process we used two types of catalysts for a catalytic reaction. Based on our information Tb⁺³ is the best ion. Ce⁺³ is the best for making light garnet silicate form. Since the attenuation period gaps between Ce⁺³ and Tb⁺³ are very large (˜10⁴ times), when simultaneously activating Tb⁺³-Ce⁺³, the Ce⁺³ ion concentration can be greatly reduced. The best ratio is [Tb]=1% atom, [Tb]/[Ce]=10³ times.

The initial activation energy transfer sensitivity mechanism occurs between Eu⁺²-Mn⁺² ions or between Eu⁺²-Sn⁺². Under these conditions, the donor ion Eu⁺² is activated by passing through an electric charge band of initial activation energy. This energy band is unique to Eu⁺² ion catalyzed oxygen base fluorescent body. Between Eu⁺² and O⁻², the electric charge transfer band rapidly absorbs initialization energy. At this time, this type of absorbed light emitting band is generated. The normal trend is towards purple-blue sub-energy band in the visible light. After absorption this type of initialization energy, Eu⁺² ion transfers to a high-energy activation position. The attenuation period does not exceed 1·10⁻⁶ seconds. If at distance <10 nm from this type of activation Eu⁺³, there are un-activated Mn⁺² ions (or Sn⁺²), then there is Eu⁺²-Mn⁺² or Eu⁺²-Sn⁺² resonance activation energy transfer. These two methods are both highly possible. The above-mentioned matching ions require concentration conditions to be maintained between 1·10²-1·10³.

Similar resonance matching catalysis ions and adding requiring concentration are the required conditions for the performance of the silicate garnet fluorescent inorganic powder of this invention.

This invention emphasizes the similarities and differences between known garnet and the materials recommended by us. Thus, the similarities are that both have cubic crystal series and a symmetric matrix. The similarity concerning the silicate garnet is that the base material has silica elements and periodic table II group elements. The basic property differences are not only in the yttrium aluminum garnet, but also in the silicate garnet, that is:

(1) Difference in chemical equivalent weight value:

a=2.5, b=3, c=2.5, z=12, replacing a=2.7-3.3, b=1.8-2.2, c=2.7-3, z=11-13;

(2) Laurylhedron valence 24 replaces the Japanese Mitsubishi Company's garnet structure of 16;

(3) In cation crystal lattice, most are Mg⁺², for Mg⁺² there are 20 tetrahedron positions; .

(4) Oxygen ion chemical equivalent precision equals to 12. It lacks the uncertainty ion contents between 11-13 for the prior art of the Japanese Mitsubishi Company's;

(5) The density of the materials described in this invention is low, and the crystal lattice parameter is low (a=11.2-11.4A);

(6) Fluorescent inorganic powder particles have low reflective coefficients n≈1.7;

(7) The activation initialization energy transfer sensitivity mechanism of catalytic ion;

(8) An electric charge transfer band is formed between Eu⁺²←O⁻² ions, and strongly absorbs activation energy.

The characteristics of the above mentioned materials have wide light absorption bands between 380-420 nm. In the fixed wavelength λ=465 nm, the absorption band is very narrow. The first absorption wide peak is related to the Eu⁺²←O² electric charge transfer band. Among them, at wavelengths of λ=465 nm, the absorption band is narrow. This is related to the tri-valence status Eu⁺³ existing in the fluorescent inorganic powder mixture. Similar fluorescent inorganic powder light emitting light spectrum are configured with multiple bands. However, in the radiation light, there are wave lengths of λ=450 nm, and λ=52 nm−λ=610 nm. This proves the possibility of obtaining white light.

In the invention, the fluorescent inorganic powder under the activation of a mercury lamp with wavelengths of λ=365 nm releases very bright white light. Under these conditions, it is apparent that the white is generated from a single composition fluorescent inorganic powder. In this fluorescent inorganic powder, there are different oxidation degree factors, such as Eu⁺³ and Eu⁺³ as well as Ce⁺³. The fluorescent inorganic powder material has a single composition, and is not a synthesized mixture material. Thus, it has a very good property—stability. That is, the light emitting color coordinates' consistency and stability are based on the reagent conditions and the complexity of the production equipment's two-dimensional or three-dimensional white light fluorescent body RGB's composition.

In the recommended individual fluorescent inorganic powder's composition, we can observe another optical phenomenon that is not presented in the previously mixed (semi-conductor fluorescent body light emitter) light source. This phenomenon has a distinguishing color that can be observed by the activated solid light source pulse length. Since the composition characteristics of the Mg_{2.4}Ca_{0.06}Eu_{0.01}Mn_{0.03}Y_{2.99}Ce_{0.01}Si_{2.5}O₁₂ is that the stable solid light source under activated conditions is white light. Furthermore, the τ<0.01 second radiation short pulse contains Mn⁺² ions possessing obvious deep blue color's unique traceable average residue light time −10 ms. Similar optical results are unique for the recommended fluorescent inorganic powder composition.

In one of the examples of this invention, the chemical formula of the fluorescent inorganic powder is:

Me⁺²_{2.5-x-y}Ln⁺³_{3-q-z-p}Si_{2.5}O₁₂:Lm₁⁺²ₓ:Lm₂⁺²_{Y}:Lm₃⁺³_{Z}:Lm₄⁺³_{P}, where Me⁺²=(Mg, and Ca one or more), Ln=(Y, Gd, Lu, and Sc one or more), Lm⁺²₁=(Eu⁺², Sm⁺² , and Yb⁺² one or more), Lm⁺²₂=(Mn⁺², and Sn⁺² one or more), Lm⁺³₃=(Ce⁺³, Tb⁺³, and Dy⁺³ one or more), Lm⁺³₄=(Eu⁺³, Tb⁺³, and Bi⁺³ one or more), x=0-0.2=[Ca]+[Lm⁺²]₁, y=0-0.2=[Ca]+[Lm⁺²]₂, z=0-02=[Lm⁺³, p=0-0.2=[Lm⁺³]₄=0-0.2.

From the above we can derive that, the limiting level of magnesium ion where Mg⁺² ion in the cation sub crystal lattice composition is 2.5 atomic units. With a specific composition, only a small quantity of Mg⁺² ion is replaced by a small quantity of Ca⁺² ions. The contents of the magnesium ion quantity will not exceed 0.1 atomic weight. Some Mg⁺² nodes combine in Lm₁⁺² Lm₂⁺² catalytic center for replacement. In f-catalysts, Eu⁺², Sm⁺², and Yb⁺² can also be used by Lm⁺², and Lm₂ ⁺². The second part of the cation node in the fluorescent inorganic powder base material can be replaced by d-catalysts, such as Mn⁺² and/or Sn⁺².

In this invention, the fluorescent inorganic powder cation sub crystal lattice rare earth element nodes include Y, Gd, Lu, and Sc atoms. These elements may appear in the fluorescent inorganic powder as individual or in pairs, such as Y and Gd, Y and Lu, Y and Sc, and Gd and Lu, Gd and Sc, as well as Lu and Sc. The concentrations of rare earth elements in pairs are [Ln₁+Ln₂]=3-p-z. At this time, the concentration of any elements in the pair is 3-q-p-z. The concentration may vary between 0.6 and 3 atomic weights.

The above-mentioned fluorescent inorganic powder implementation example chemical formula is Mg_{2.5-x-y}Sm⁺²ₓCa_{y}Y₃Gd_{z}Ce⁺³_{z}Si_{2.5}O₁₂. When activated under short wave light conditions, it emits green-yellow light. The color coordinates are x>=0.30 and y>=0.32.

The chemical formula for another example of the above-mentioned fluorescent inorganic powder is Mg_{2.5-x-y}Eu⁺²ₓCa_{y}Y₃₋ₚLu_{1-z}Gd_{z}Ce⁺³_{z}Tb⁺³ₚSi_{2.5}O₁₂. Under the activation condition of λ≦420 nm short wave light, it emits blue-green-yellow multiple band radiation. The residual light length is τ≦1.5 ms.

The chemical formula of another example of the fluorescent inorganic powder is Mg_{2.5-x-y-z}Eu⁺²ₓCa_{y}Sn⁺²_{y}Y_{3-z-q}Lu_{1-z}Gd_{q}Ce⁺³_{z}Si_{2.5}O₁₂. When activated under condition of wavelength at λ≦420 nm short wave light, it emits blue-red-yellow radiation. The color coordinates are x≧0.35, y≧0.35.

The above-mentioned fluorescent inorganic powder has the following chemical formula:

Mg_{2.5-x-y-z}Eu⁺²ₓCa_{y}Mn⁺²_{z}Gd_{2-q}Si_{2.5}O₁₂, when under activation conditions of λ<=450 nm short wave light, it emits blue-green-orange yellow half wave multiple band radiation. The color marks combine with part of the initialization radiation, equal to Rₐ>85.

The above-mentioned fluorescent inorganic powder may have two activation centers for activation, respectively located in cation sub crystal lattice and anion sub crystal lattice. The chemical formula is Mg_{2.5-x-y-z}Eu⁺²ₓCa_{y}Mn⁺²Y_{3-q}Ce_{z}Gd_{q}PrₚSi_{2.5}O₁₂. Furthermore, it emits light at the visible light half wave blue-green-orange yellow areas to form the multiple band radiation.

The above-mentioned silicon dioxide concentration does not change in the fluorescent inorganic powder. It uses 2.5 moles to form a fluorescent inorganic powder sub crystal lattice. For an example of this invention to describe silicate garnet base material fluorescent inorganic powder, please refer to Table 2:

TABLE 2

| Item | | | |
|---|---|---|---|
| number | fluorescent body composition | λ_{radiation} nm | Λ_{absorption} nm |
| 1 | Mg_{2.5}Y₃₋ₓCeₓSi_{2.5}O₁₂ | 560 | 460 |
| 2 | Mg_{2.5}Y₂₋ₓCeₓLu₁Si_{2.5}O₁₂ | 545 | 450 |
| 3 | Mg_{2.5}Y_{3-x-y}Gd_{y}CeₓSi_{2.5}O₁₂ | 570 | 455 |
| 4 | Mg_{2.5}Y_{1.5}Gd_{1.45}Ce_{0.05}Si_{2.5}O₁₂ | 590 | 470 |
| 5 | Mg_{2.5}Y_{2.5}Gd_{0.45}Ce_{0.05}Si_{2.5}O₁₂ | 555 | 465 |
| 6 | Mg_{2.5}Y_{2.5}Gd_{O.44}Ce_{0.05}Pr_{0.01}Si_{2.5}O₁₂ | 560, 610 | 460 |
| 7 | Mg_{2.5}Y_{2.2}Lu_{0.75}Ce_{0.04}Pr_{0.01}Si_{2.5}O₁₂ | 540 | 440 |
| 8 | Mg_{2.4}Ca_{0.06}Eu_{0.02}Mn_{0.02}Y_{2.9}Ce_{0.01}Tb_{0.09}Si_{2.5}O₁₂ | 480, 520, 545 | 440 |
| 9 | Mg_{2.4}Ca_{0.06}Eu_{0.02}Sn_{0.02}⁺²Y_{1.5}Lu_{1.49}Ce_{0.01}Si_{2.5}O₁₂ | 480, 620 | 450 |
| 10 | Mg_{2.5}Y_{2.94}Tb_{O.005}EU_{0.055}Si_{2.5}O₁₂ | 465 | 610 |
| 11 | Mg_{2.5}Y_{2.98}Eu⁺²_{O.01}Hf_{0.01}Si_{2.5}O₁₂ | 380-420 | 500 |
| 12 | Mg_{2.5}Lu_{2.0}Y_{0.95}Eu⁺²_{O.01}Zr_{0.01}Eu⁺³Tb_{0.01}Si_{2.5}O₁₂ | 380-440 | 480-545, 610 |
| 13 | (Ca_{2.97}Ce_{0.03})Sc₂Si₃O_{12.015} - standard | 545 | 450 |

Table 2 presents 1-, 2-, 3- and 4-catalyst garnet fluorescent inorganic powders. Among them, the fluorescent inorganic powder series belong to the first type, and the main components are catalyzed by Ce⁺³. Comparing standards for these fluorescent inorganic powder are standard Y₃Al₅O₁₂:Ce or prototype Ca_{2.97}Ce_{0.03}Sc₂Si₃O_{12.015}.

The second catalyst components can also be separated into two groups. For the first group, the two active catalytic centers are in the Mg ion sub crystal lattice. The catalytic centers for the second group fluorescent inorganic powder are respectively located in the Mg ion, and Ln ion sub crystal lattices. The two catalytic cenetrs for the third group fluorescent inorganic powder may be in the Mg or Ln ionsub crystal lattice. The third catalytic factors corresponds to Ln or Mg sub crystal lattices. The fourth group fluorescent inorganic powder may have the highest number. The reason for this is that, when appearing in combination in different sub crystal lattices, especially when dissimialar valence combination compensation principle are used, the catalytic factors may appear in many different combinations. Furthermore, the dissimialar valence combination compensation principle may be used in other fluorescent inorganic powder methods. Adding large quantities of high valence ions to cation sub crystal lattice nodes will give these materials additional crystal chemical properties. The concentration of the added ions equals the concentration of the replaced catalytic factors in the nodes. Normally, it would not exceed m=[Me⁺⁴]≦0.05. The listed four sets of fluorescent inorganic powder implementation example parameters are shown in Table 3:

TABLE 3

| | | | Relative performance | |
|---|---|---|---|---|
| | | | when activated by | |
| Item | | Light | wavelength λ = 405, | |
| No. | Composition | color | 450 | |
| I | | | | |
| 1.1 | Mg_{2.5}Y_{2.97}Ce_{0.03}Si_{2.5}O₁₂ | green-yellow | 100 | 100 |
| 1.2 | Mg_{2.5}Y_{1.97}Ce_{0.03}Lu₁Si_{2.5}O₁₂ | green-yellow | 102 | 105 |
| 1.3 | Mg_{2.5}Y_{2.98}Eu_{O.01}Hf_{0.01}Si_{2.5}O₁₂ | green | 110 | 78 |
| 1.4 | Mg_{2.5}Y_{1.5}Gd_{1.45}Ce_{0.05}Si_{2.5}O₁₂ | yellow-orange yellow | 125 | 135 |
| II | | | | |
| 2.1 | Mg_{2.49}Y_{1.5}Yb_{0.01}Gd1_{.45}Ce_{0.05}Si_{2.5}O₁₂ | Yellow | 126 | 138 |
| 2.2 | Mg_{2.4}Ca_{0.08}Eu_{0.02}Y_{2.9}Ce_{0.01}Ce_{0.01}Si_{2.5}O₁₂ | Light green-yellow | 120 | 85 |
| 2.3 | Mg_{2.4}Ca_{0.07}Eu_{0.02}Yb_{0.01}Y₃Si_{2.5}O₁₂ | Light green | 108 | 68 |
| III | | | | |
| 3.1 | Mg_{2.4}Ca_{0.06}Eu_{0.02}Mn_{0.02}Y_{2.99}Ce_{0.01}Si_{2.5}O₁₂ | Light green-yellow | 140 | 89 |
| 3.2 | Mg_{2.4}Ca_{0.08}Eu_{0.02}Y_{2.9}Ce_{0.01}Tb_{0.09}Si_{2.5}O₁₂ | Green | 150 | 86 |
| IV | | | | |
| 4.1 | Mg_{2.4}Ca_{0.06}Eu_{0.02}Sn_{0.02}Y_{1.5}xxLu_{1.49}Ce_{0.005}Tb_{0.005}Si_{2.5}O₁₂ | green-yellow-red (white) | 138 | 70 |
| 4.2 | Mg_{2.4}Ca_{0.05}Eu_{0.02}Mn_{0.03}Y_{2.5}Gd_{O.44}Ce_{0.05}Pr_{0.01}Si_{2.5}O₁₂ | green-yellow-red (white) | 150 | 108 |
| V | Ca_{2.97}Se_{0.03}Sc₂Si₃O₁₂- [symbol] | light yellow | 80 | 75 |
| | Y_{2.97}Ce_{0.03}Al₅O₁₂- [symbol] | yellow | 75 | 100 |

The conclusions drawn from Table 3 are that the suggested silicate garnet composition can obtain the fluorescent inorganic powder, when activated by UV wave lenght of λ>365 nm and generate different light colors and can obtain compositions with different strengths. That is, for this series of composition, when activated by short waves of λ=405 nm, it will have a high strength lighting value. When activated by wavelengths of λ=450 nm, the strength is lowered.

The diversified fluorescent materials in the the above-mentioned invention are generated by the characteristics of the inorganic basis:

(1) For introduced catalysts, there are two base material sub crystal lattices;

(2) The controlling of oxidation states by the catalyst light emitting centers are relatively easy;

(3) The introduced light emitting centers have high gathering properties; and

(4) The cubic properties in the crystal lattices and large quantity of high valences catalytic centers exist in the lattices.

The fluorescent inorganic powder of this invention not only has a new composition, but also the production method is different. The procedures are:

(1) A two stage heat treatment of the fluorescent inorganic powder ion sub crystal lattice oxidation composition and all added catalytic ions, at this time, the reduction environment heat treatment is used;

(2) During the second heat treatment process, the process carries out the mixing of the two-cation components and the silicon dioxide gas melting glue anion. The ratio is: 2.5:3:2.5. The operation conditions are a neutral or a weak reduction environment. The process requires maintaining for 2-10 hours a temperature of T=1100-1400° C.

What follows are the actual implementation examples of this fluorescent inorganic powder invention:

### EXAMPLE 1

(1) Mix 1.485M Y₂O₃ and 0.03M [symbol] CeO₂;

(2) Calcine the mixture at T=1400□ temperature and H₂:N₂=(2:98) environment for 2 hours;

(3) Add 2.5M MgO and 2.5M SiO₂ into the obtained product, and carefully add 10 gm NH₄Cl, mix well and place at T=1300□ temperature and calcine for 3 hours, the furnace pressure N₂ is maintained at p=100 mm water column. Cool the product in N₂ atmosphere to 80° C.;

(4) Wash clean with diluted HCl (1:10) solution, bake for 3 hours at T=120° C. temperature;

(5) Then, screening with 500 mesh screen, and select 95 weight % final products.

The synthesized fluorescent inorganic powder is yellow in color. It can effectively accept λ<420 nm UV and blue light for activation. Observing the fluorescent inorganic powder particles with optical microscope, they appear as pine forest stone shapes or prism shaped. The medium line diameter is d₅₀=2-4 mm. The average diameter is d_{cp}=6-8 mm. The maximum particle diameter is d₁₀₀=25 mm. The diameter is d₉₇=20 mm. Performing mineral analysis with liquids of different reflective rates shows that the light reflective rate of the fluorescent inorganic powder is n_{π-p}=1.69 units. Mixing similar fluorescent inorganic powder with silicone, that has a reflective rate of 1.46, and under the conditions of filling with 60% by weight fluorescent inorganic powder, Ga—In—N is added to the container that has crystal fixing seat with dissimilar material combination semi-conductor fixed on it. The volume of the added mixture shall be selected so that, after solidification, the obtained fluorescent inorganic powder polymer layer will have a uniform thickness on light emitting surfaces and light emitting side surfaces. Under the input of U=3.8 volt voltage and J=20 m-amp current power supply, uniform white light can be obtained from the solid light source. The coordinate is x=0.33, y=0.34.

### EXAMPLE 2

(1) Mix 2.4M MgO and 0.05M CaCO₃, 0.015M Eu₂O₃ and 0.02M MnCO₃;

(2) Calcine the mixture at T=1200□ temperature and H₂:N₂=(5:95) environment for 3 hours;

(3) At the same, add 1.25M Y₂O₃ and 0.22M Gd₂O₃ and 0.05M CeO₂ and 0.0025M Pr₄O₇, mix well and place at T=1300□ temperature and calcine;

(4) In N₂ media, add H₂ gas with concentration at H₂=5%;

(5) Mix these two products with 2.5M SiO₂; and

(6) Calcine again at T=1350° C. temperature, under 1% H₂ atmosphere.

The products are composed of column crystals and are prism shaped. It appears as a yellow-green color. When activated by λ=365 nm UV light, the fluorescent inorganic powder emits very bright white light. When activated by λ=450 nm blue light, this material emits a bright yellow light. Thus, the fluorescent inorganic powder has a high light lamination parameter.

The fluorescent light organic powder of this invention can not only be excited and illuminated by shortwave radiation with a wavelength of λ≦405 nm (nanometer), but it can also emit supplementary light under the reaction of standard indium gallium nitride semi-conductor with a wavelength of λ≦405 nm˜λ≦500 nm. Under these conditions, compared to the Stocks frequency shift (wave length 95-105 nm) of the standard fluorescent light powder ((Y, Gd, Ce)₃Al₅O₁₂), there is a small Stocks frequency shift between the excited and emitted fluorescent light (35-40).

This property is most prominent with blue fluorescent light. Based on calculations, the quantum export of higher than q=75% is a better practical choice.

This type of fluorescent light organic powder emitted fluorescent light chromaticity spectrum configuration changes within the range of λ=510 nm to λ=640 nm. Furthermore, the fluorescent light strength emitted within the visible light sub-wave's wavelength combines with the unabsorbed blue light portion of the semi-conductor different material combination. It is sufficient to produce all types of colors and white light of all color tunes, from cold white light to sunlight and moonlight.

At the present time, there is no precise physical explanation for the fluorescent light organic powder properties proposed in the above-mentioned invention. However, it can be verified that the ion Eu⁺² excited on the base of the materials has very strong fluorescent light emission properties. It then forms uneven intra crystal magnetic field within the fluorescent light powder lattices. This is produced by components of cations and anions with different ion diameters. In reality, these ions may be smaller than the atoms of the excited elements, or larger. The uneven properties of the electric filed accelerate the rapid re-distribution of different F-f class of Eu⁺² of F-d class of Ce⁺³. This shows as changing properties in the radiation spectrum. The close distance distribution between the above-mentioned stimulants and the small particles of Mg⁺², Si⁺², and Ca⁺², can eliminate the non-radiation conversion conditions from the excited class to the base ions of the stimulants. In reality, this increases the quantum output of the fluorescent light.

All the fluorescent light organic powder properties proposed in this invention enable fluorescent light to emit the following colors under standard solid light source (λ=467 nm). The implementation example uses blue solid light source as the excited light:

1) Green light: main color wavelength is λ=505 nm. It uses blue diodes to excite fluorescent light organic powder with main components of Ca_{2.5}Ln₃Si_{2.5}O₁₂:Eu⁺²;

2) White light: the chromaticity coordinates are X=0.3092, Y=0.3160. The main color wavelength is λ=570 nm. It uses blue diodes to excite fluorescent light organic powder with main components of (Ca,S₂)_{2.5}Ln₃Si_{2.5}O₁₂:Eu⁺²;

3) Yellow light: the chromaticity coordinates are X=0.3901, Y=0.4739. The main color wavelength is λ=558 nm. It uses blue diodes to excite fluorescent light organic powder with main components of (Ca, S₂)_{2.5}Ln₃Si_{2.5}O₁₂:Eu⁺²;

(4) Orange yellow light: the chromaticity coordinates are X=0.44, Y=0.52. The main color wavelength is λ=572 nm. It uses blue diodes to excite fluorescent light organic powder with main components of (Ca,S₂,Ba)_{2.5}Ln₃Si_{2.5}O₁₂:Eu⁺².

In summary, this invention is a type of fluorescent inorganic powder for a UV light solid light source. The fluorescent inorganic powder is produced based on garnet silicate composition. Through the semi-conductor's different material combination emitted short wave light activation conditions, it establishes multiple band radiation white light. It is a rare invention with industrial applications, innovations and advancements. It meets the key patent application requirement. Thus, the application is submitted based on the law. Please review in detail and grant a patent to this case to protect the rights of the inventor. However, the above-described examples are only these better and feasible implementation examples. They are not used to limit the applications of the patent scopes of this invention. Any applications, which utilize the variations of the contents of the descriptions and drawings of this invention and have equivalent performance structure, are included in the scopes of this invention.

This point is stated clearly here.

1. A type of fluorescent inorganic powder for a UV light solid light source, wherein said powder is a fluorescent inorganic powder composition produced based on garnet silicate components that can be activated by rare earth ions, and the main component of the fluorescent inorganic powder is Me⁺²_{2.5-x-y}Ln⁻³_{3-q-z-p}Si_{2.5}O₁₂:Lm₁⁺²ₓ:Lm₂⁺²_{Y}:Lm₃⁺³_{Z}:Lm₄⁺³_{P}, whereby the powder uses the activation conditions generated by dissimilar material semi-conductor emitted short wave light to establish multiple band radiation white light.

2. The fluorescent inorganic powder for the UV light solid light source as described in claim 1, wherein Me⁺²=(Mg, and Ca one or more), Ln=(Y, Gd, Lu, and Sc one or more), Lm⁺²₁=(Eu⁺², Sm⁺², and Yb⁺² one or more), Lm⁺²₂=(Mn⁺², and Sn⁺² one or more), Lm⁺³₃=(Ce⁺³, Tb⁺³, and Dy⁺³ one or more), Lm⁺³₄=(Eu⁺³, Tb⁺³, and Bi⁻³ one or more), x=0-0.2=[Ca]+[Lm⁺²]₁, y=0-0.2=[Ca]+[Lm⁺²]₂, z=0-02=[Lm⁺³]₃, p=0-0.2=[Lm⁺³]₄=0-0.2.

3. The fluorescent inorganic powder for the UV light solid light source as described in claim 1, where 12 times of Ce⁺³, Eu⁻³, Tb⁺³, and Dy⁺³ ions are added to the Ln nodes, is used to establish activation nodes with high radiation strength, that is, it is the activation agent.

4. The fluorescent inorganic powder for the UV light solid light source as described in claim 1, where, the Ce⁺³ and Tb⁺³ catalyzed materials absorbed solid light source's wavelength is λ=445-455 nm or λ=365-395 nm energy.

5. The fluorescent inorganic powder for the UV light solid light source as described in claim 1, wherein the chemical formula for the fluorescent inorganic powder is Mg_{2.5-x-y}Sm ⁺²ₓCa_{y}Y₃Gd_{z}Ce⁺³_{z}Si_{2.5}O₁₂, when under activation conditions utilizing short wave light, said fluorescent inorganic powder emits a green-yellow light having color coordinates of x>=0.30 and y>=0.32.

6. The fluorescent inorganic powder for the UV light solid light source as described in claim 1, wherein the chemical formula for the fluorescent inorganic powder is Mg_{2.5-x-y}Eu⁺²ₓCa_{y}Y₃₋ₚLu_{1-z}Gd_{z}Ce⁺³_{z}Tb⁺³ₚSi_{2.5}O₁₂, when under activation conditions of λ≦420 nm short wave light, it emits a blue-green-yellow multiple band radiation having residue light length of τ≦1.5 ms.

7. The fluorescent inorganic powder for the UV light solid light source as described in claim 1, wherein the chemical formula for the fluorescent inorganic powder is Mg_{2.5-x-y-z}Eu⁺²ₓCa_{y}Sn⁺²_{y}Y_{3-z-q}Lu_{1-z}Gd_{q}Ce⁺³_{z}Si_{2.5}O₁₂, when under activation conditions of wavelength λ≦420 nm short wave light, it emits a blue-red-yellow radiation having color coordinates of x≧0.35, y≧0.35.

8. The fluorescent inorganic powder for the UV light solid light source as described in claim 1, wherein the chemical formula for the fluorescent inorganic powder is Mg_{2.5-x-y-z}Eu⁺²ₓCa_{y}Mn⁺²_{z}Gd_{2-q}Si_{2.5}O₁₂, when under activation conditions of λ<=450 nm short wave light, it emits a blue-green-orange yellow half wave multiple band radiation, whereby color marks are combined with part of the initialization, and are equal to Rₐ>85.

9. The fluorescent inorganic powder for the UV light solid light source as described in claim 1, wherein the fluorescent inorganic powder has two activation centers for activation, corresponding to locations in cation sub crystal lattice and anion sub crystal lattice, wherein the chemical formula is Mg_{2.5-x-y-z}Eu⁺²ₓCa_{y}Mn⁻²Y_{3-q}Ce_{z}Gd_{q}PrₚSi_{2.5}O₁₂, and the powder eliminates at the visible light half wave blue-green-orange yellow area and forms multiple bands of radiation.

10. The fluorescent inorganic powder for the UV light solid light source as described in claim 1, wherein the fluorescent inorganic powder has multiple dispersion particle shapes and pine forest rock shapes, the medium line diameter is d₅₀=2-4 mm, the average particle diameter is d_{cp}=6-8 mm, and the particle diameters are d₉₇=20 mm and d₁₀₀=25 mm.

11. The fluorescent inorganic powder for the UV light solid light source as described in claim 1, wherein the ratios of reflection coefficients and combination connection coefficients for the fluorescent inorganic powder are from 1.65:1.45 to 1.8:1.55, and the material can form a stable suspension, wherein the mass content of the fluorescent inorganic powder particle is 10-75%, whereby the fluorescent inorganic powder particle is able to establish a uniform layer with a thickness from between 20 mm to 200 mm.

12-13. (canceled)
